(19) United States
(12) Patent Application Publication
(10) Pub. No.: US 2008/0282989 A1
(43) Pub. Date: Nov. 20, 2008

(54) C-CLIP HUMMINGBIRD FEEDER

(75) Inventor: DAVID E. NYLEN, West Des Moines, IA (US)

Correspondence Address: MCKEE, VOORHEES & SEASE, P.L.C., 801 GRAND AVENUE, SUITE 3200, DES MOINES, IA, 50309-2721, US

(73) Assignee: WOODLINK, LTD., West Des Moines, IA (US)

(21) Appl. No.: 11/748,660

(22) Filed: May 15, 2007

(51) Int. Cl. A01K 39/01

(52) U.S. Cl. 119/72

(57) ABSTRACT

A hummingbird feeder includes a cup and a C-shaped clip for mounting on the upper rail of a deck. Various forms of a male and female coupling is provided on the cup and the clip so as to quickly and easily connect the cup and clip, including a snap fit, a friction fit, a threadable coupling, a detent coupling, and a twist lock assembly. The clip may be oriented horizontally or vertically upon the deck rail or other supporting structure.

### FIELD OF THE INVENTION

The present invention is directed towards bird feeders, and particularly, a hummingbird feeder which is clipped to a support, such as the upper rail of a deck.

### BACKGROUND OF THE INVENTION

Hummingbird feeders come in a variety of shapes, all of which are typically hung from a hook. However, sometimes there is not a convenient place to attach or hang the hook to support the bird feeder. For example, some residential houses do not have trees from which to hang a feeder, or the trees are too far from a desired location, such as a window or deck. Some prior art feeders have overcome this limitation by providing a hook which is mounted to a deck railing using a clamp. However, such a deck-mounted hook creates an undesirable structure (the support rod) adjacent the feeder.

Therefore, a primary objective of the present invention is the provision of a hummingbird feeder which can be clipped to a deck rail without a hanging hook to support the feeder.

Another objective of the present invention is the provision of a hummingbird feeder which can be quickly and easily mounted to a deck rail.

A further objective of the present invention is the provision of a bird feeder having a base mountable to a clip which is slidably mounted on a deck rail.

Still another objective of the present invention is the provision of a bird feeder which can be safely and securely set on the top of a deck rail.

Yet another objective of the present invention is the provision of a hummingbird feeder which is free from structural support at the upper end of the feeder.

A further objective of the present invention is the provision of a deck mounted bird feeder which can be easily positioned anywhere along a deck rail.

Another objective of the present invention is the provision of a hummingbird feeder which mounts to a deck rail without the use of screws or other hardware.

A further objective of the present invention is the provision of a hummingbird feeder which is economical to manufacture and durable in use.

These and other objectives will become apparent from the following description of the invention.

### BRIEF SUMMARY OF THE INVENTION

The hummingbird feeder of the present invention generally includes a cup having a base, a stem, and an upper reservoir for holding nectar or other food. A C-shaped clip includes a top leg, a bottom leg, a web connecting the top and bottom legs, and an open side for mounting the clip onto a deck rail. The cup is connected to the clip by a coupling means in the form of a male and female connection between the clip and the cup. The coupling connection may be a snap fit, a friction fit, threadable coupling, a twist lock assembly, or an opening or a slot in the clip to receive a portion of the cup.

### BRIEF DESCRIPTION OF THE DRAWINGS

FIG. 1A is perspective view showing the hummingbird feeder of the present invention mounted on a deck rail.

FIG. 1B is an exploded view of the hummingbird feeder showing a first feeder embodiment having a peg coupling between the cup and clip.

FIG. 2 is a sectional view of the feeder cup and C-shaped clip of the hummingbird feeder.

FIG. 3 is a view of a second alternative embodiment of the feeder utilizing a twist lock coupling connection between the cup and the clip.

FIG. 4 is a view of a third alternative embodiment showing a threaded coupler connection between the cup and the clip.

FIGS. 5 and 6 are views of a fourth alternative embodiment of the feeder wherein the clip has a recess for mounting the cup.

FIGS. 7 and 8 are views of a fifth alterative embodiment of the feeder wherein the clip has a slot for receiving a portion of the cup.

FIG. 9 is a view of a sixth alternative embodiment of the feeder utilizing a snap fit coupling connection between the cup and the clip.

FIG. 10 is a view of a seventh alternative embodiment of the feeder showing a detent coupling connection between the cup and the clip.

### DETAILED DESCRIPTION OF THE PREFERRED EMBODIMENT

The hummingbird feeder of the present invention is generally designated by the reference numeral 10 in the drawings. The feeder comprises a cup 12 and a C-shaped clip 14 which is adapted to be mounted on a deck rail 16.

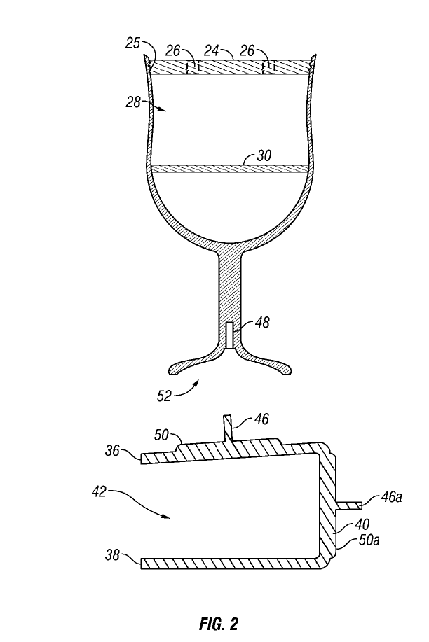

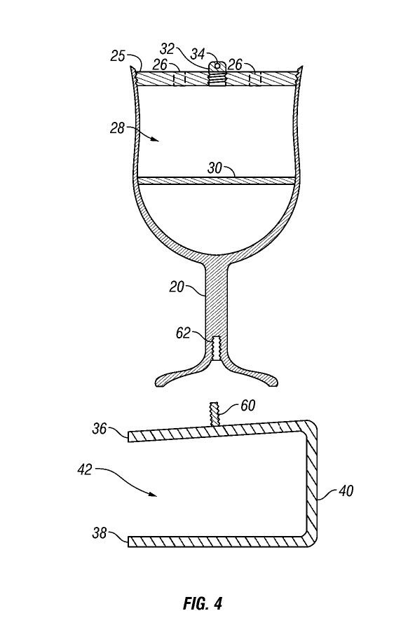

The cup 12 may take various forms. One preferred form is shown in the drawings, wherein the cup 12 includes a base 18, a stem 20, and an upper body or reservoir 22 for holding nectar. A lid 24 is removably mounted on the body 22 in any convenient manner, such as by threads 25, as seen in FIGS. 2 and 4. The lid 24 includes holes 26 through which a hummingbird's beak may extend for feeding on nectar contained within the cavity 28 of the body 22. A false bottom 30 may be provided in the cavity 28 to reduce the depth of the cavity. A removable plug 32 may be provided in the lid 24 to allow the cavity 28 to be filled. The plug 32 may include a hole 34 for receiving a hook to hang the cup 12, as an alternative to mounting the cup 12 on the clip 14, as described below.

The clip 14 includes an upper leg 36, a lower leg 38, and a web 40 interconnecting the upper and lower legs 36, 28. The legs 36, 38 and web define a C-shape with an open side 42 such that the clip 14 can be slidably mounted on the deck rail 16 or upon another supporting structure. As seen in FIG. 2, preferably the legs 36, 38 of the clip 14 are not parallel, but rather converge towards one another adjacent the opening 42, which is slightly narrower than the thickness of the deck rail 16. The clip 14 is constructed of a resilient material, such as plastic, such that the legs 36, 38 are spread apart for mounting on the deck rail 16, with the spring force between the legs 36, 38 retaining the clip 14 on the deck rail 16, without the use of screws or other mounting hardware. As seen in FIG. 10, the outer edges of the legs 36, 38 may have a curved tip 44 to facilitate mounting of the clip 14 onto the deck rail 16.

The drawings show various coupling means for quickly, easily, and securely mounting the cup 12 onto the clip 14. Generally, the coupling means are in the form of a male and female connection with one of the cup or clip being received into or onto the other of the cup and the clip.

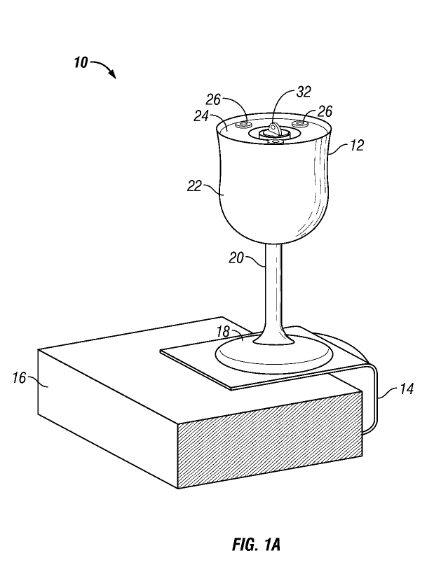

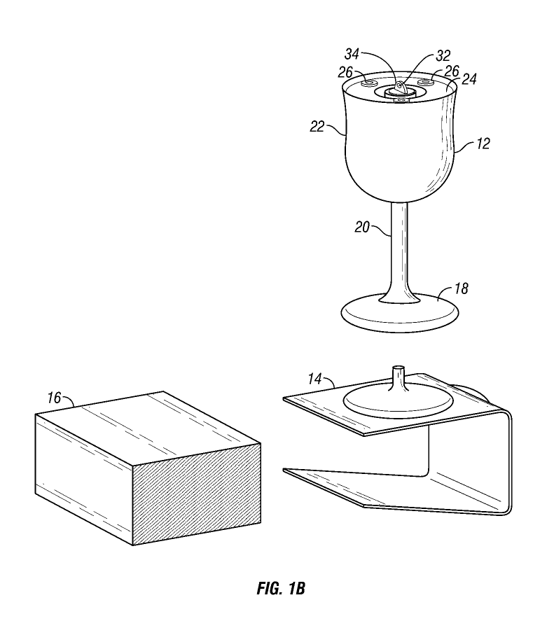

FIGS. 1B and 2 show a first embodiment of the coupling means. More particularly, the upper leg 36 of the clip 14 includes an upstanding peg 46 which is received in a recess 48 extending upwardly from the base 18 of the cup 12 and into the stem 20. The peg 46 and the recess 48 have a friction fit therebetween. The upper leg 36 may also include an enlarged diameter disk 50 to matingly fit within the hollow diameter 52 of the base 18.

As best seen in FIG. 2, a peg 46A and disk 50A may also be formed on the web 40 of the clip 14 in the event that the clip 14 is mounted on a support structure with the open side 42 facing downwardly, as opposed to laterally as shown in FIG. 1B.

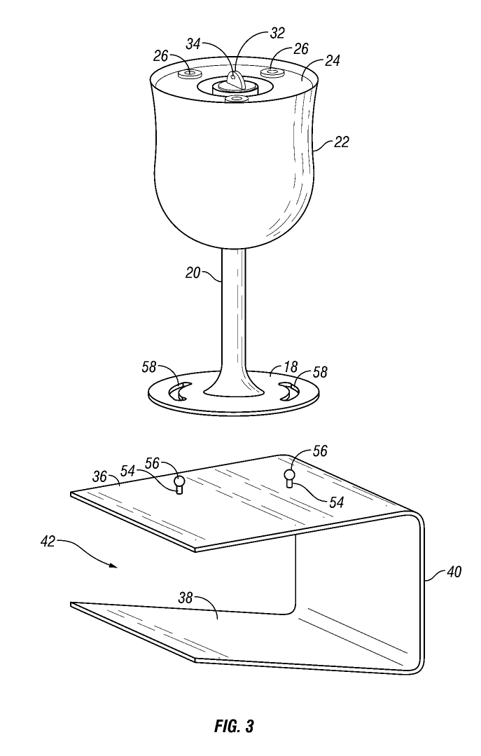

FIG. 3 shows a second alternative embodiment of the coupling means in the form of a twist lock assembly. More particularly, the twist lock assembly includes a pair of upstanding pegs 54 with enlarged heads 56 on the upper leg 36 of the clip 14. The base 18 of the cup 12 has a pair of curved slots 58, each having opposite enlarged ends through which the heads 56 of the pegs 54 extend. The cup 12 can then be rotated about the axis of the stem 20 to lock the cup 12 in place on the clip 14.

FIG. 4 shows a third alternative embodiment of the coupling means in the form of a threaded connection between the cup 12 and the clip 14. The clip 14 includes a threaded peg 60 for mating threaded engagement with a threaded aperture 62 in the stem 20 of the cup 12. It is understood that the base 18 may be solid, rather than hollow as shown in FIG. 4, with a threaded aperture in the base 18 for receiving the threaded peg 60 of the clip 14.

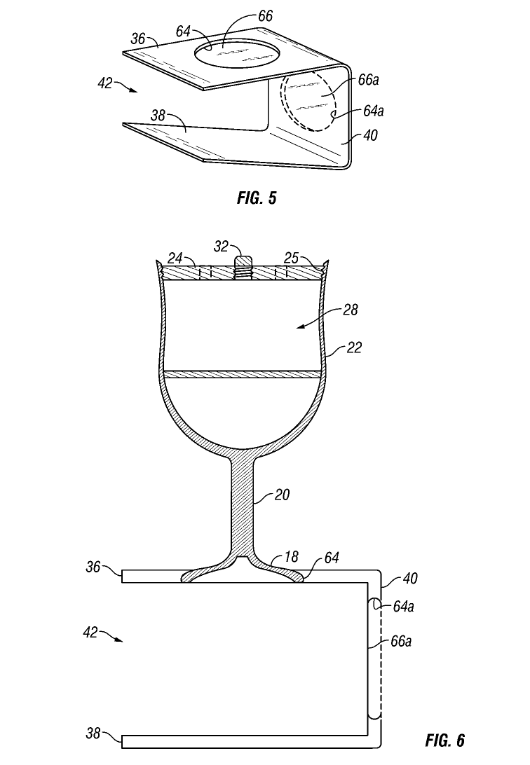

FIGS. 5 and 6 show a fourth alternative embodiment of a coupling means in the form of an enlarged diameter recess 64 in the top leg 36 of the clip 14. The recess 64 has a diameter matching the diameter of the base 18 of the cup 12 such that the cup 12 can be pressed or snap fit into the recess 64 for retention on the clip 14. The recess 64 has a floor 66, rather than being a hole extending through the upper leg 36. A similar recess 64A and floor 66A may be provided on the web 40 of the clip 14 for use when the clip 14 is mounted on a support structure with the legs 36, 38 extending vertically, as opposed to the horizontal orientation shown in FIG. 6.

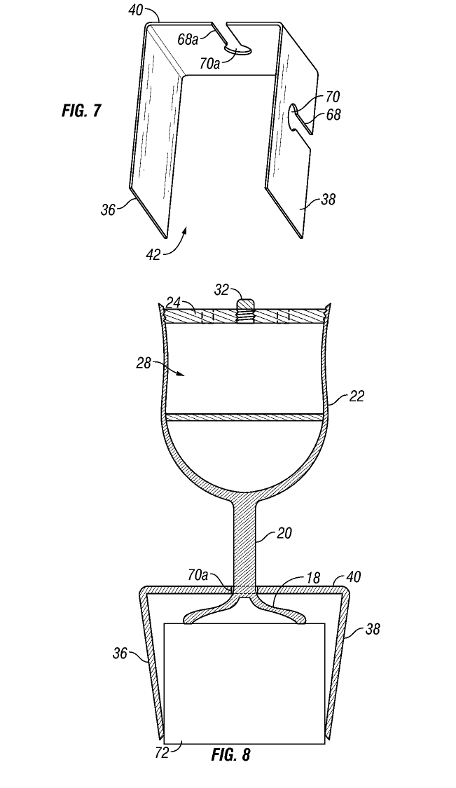

FIGS. 7 and 8 show a fifth alternative embodiment for the coupling means. In this embodiment, the clip 12 has a slot 68 extending from one edge and terminating in a central aperture 70 in the upper leg 36 of the clip 14. The stem 20 of the cup 12 is adapted to slide into the slot 68, with the base 18 positioned between the upper leg 36 and the rail 16 or other support structure. It is noted that in FIG. 8, the clip 14 is shown mounted on a structure 72 in a vertical orientation, with the cup 12 received in the slot 68A and central aperture 70A of the web 40.

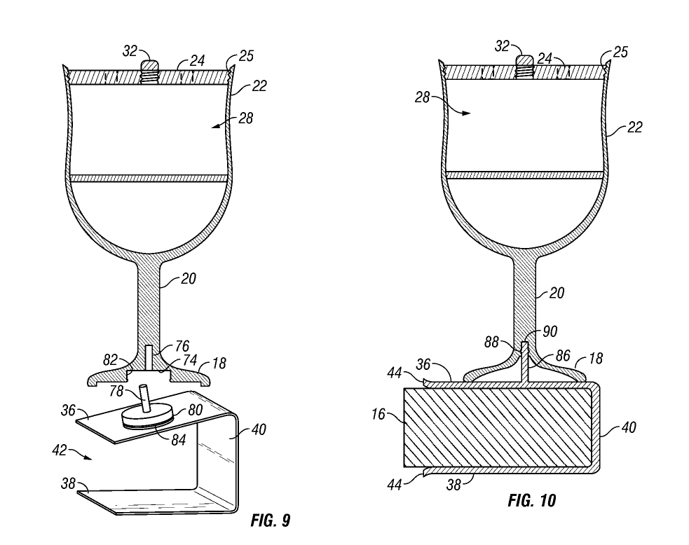

FIG. 9 shows yet another alternative embodiment of the coupling means in the form of a snap fit connection. More particularly, the cup 12 includes a large diameter recess 74 in the base 18 and a small diameter aperture 76 extending into the stem 20. The upper leg 36 of the clip 14 includes a peg 78 adapted to extend into the aperture 76 and a plug 80 adapted to be received in the recess 74. The recess 74 includes a rib 82 extending around the circumference thereof which is received in a perimeter groove 84 in the plug 80. It is understood that the rib can alternatively be provided on the plug 80, with the groove being formed in the recess 74. In either construction, the cup 12 snap fits onto the clip 14 via the rib and groove coupling.

FIG. 10 shows yet another alternative embodiment of the coupling means. In this embodiment, an upstanding peg 86 on the upper leg 36 of the clip 14 includes a detent 88 for receipt in a mating groove in an aperture 90 in the stem 20 of the cup 12. It is understood that the detent and groove arrangement can be reversed, such that the detent is formed in the aperture 90 of the stem 20 and the groove is formed in the peg 86. The detent 88 may be spring biased. As a further alternative, the base 18 of the cup 12 may be solid, as opposed to hollow as shown in FIG. 10, with a shortened peg and detent connection between the clip and base 18 of the cup 12.

It is understood that each of the alternative embodiments of the coupling means can be provided on both the upper leg 36 of the clip, as well as the web 40 for the clip 14, even through the drawings do not show such a structure in each instance. It is also understood that the cup 12 may take various shapes, without departing from the scope of the present invention.

The invention has been shown and described above with the preferred embodiments, and it is understood that many modifications, substitutions, and additions may be made which are within the intended spirit and scope of the invention. From the foregoing, it can be seen that the present invention accomplishes at least all of its stated objectives.

1. A hummingbird feeder, comprising:
a C-shaped clip having a top leg, a bottom leg, a web connecting the top and bottom legs, and an open side for mounting the clip on a deck rail;
a cup for holding nectar; coupling means on the top leg of the clip for mounting the cup onto the clip.

2. The hummingbird feeder of claim 1 wherein the clip slidably mounts on the deck rail.

3. The hummingbird feeder of claim 1 wherein the clip is free from hardware for mounting onto the deck rail.

4. The hummingbird feeder of claim 1 wherein the coupling means is an upright peg matingly received in an opening in the cup.

5. The hummingbird feeder of claim 4 wherein the peg is friction fit in the opening.

6. The hummingbird feeder of claim 4 wherein the peg is snap fit in the opening.

7. The hummingbird feeder of claim 4 wherein the peg is threadably received in the opening.

8. The hummingbird feeder of claim 1 wherein the coupling means is a twist lock assembly.

9. The hummingbird feeder of claim 8 wherein the twist lock assembly includes at least one upright peg on the clip and a slot in the cup to receive the peg.

10. The hummingbird feeder of claim 1 wherein the coupling means is a recess in the clip adapted to receive a portion of the cup.

11. The hummingbird feeder of claim 10 wherein the cup snap fits into the recess.

12. The hummingbird feeder of claim 10 wherein the cup slides into the recess.

13. The hummingbird feeder of claim 1 wherein the coupling means includes a detent.

14. The hummingbird feeder of claim 1 wherein the cup includes a base, a stem, and an upper reservoir for holding the nectar.

15. A deck mountable bird feeder, comprising:
a reservoir for holding bird food;
a C-shaped clip for mounting on an upper rail of the deck; and
a male and female connection between the reservoir and the clip.

16. The bird feeder of claim 15 wherein the connection is snap fit.

17. The bird feeder of claim 15 wherein the connection is friction fit.

18. The bird feeder of claim 15 wherein the connection is threadably coupled.

19. The bird feeder of claim 15 wherein the connection is a twist lock assembly.

20. The bird feeder of claim 15 wherein the reservoir is a cup having a base, a stem and an upper body for holding nectar.
